(19) United States
(12) Patent Application Publication
(10) Pub. No.: US 2008/0199720 A1
(43) Pub. Date: Aug. 21, 2008

(54) POROUS METAL FOAM STRUCTURES AND METHODS

(75) Inventor: Hengda Liu, Warsaw, IN (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: DePuy Products, Inc., Warsaw, IN (US)

(21) Appl. No.: 11/677,140

(22) Filed: Feb. 21, 2007

(51) Int. Cl. B32B 1/00; B22F 1/00; B22F 5/10

(52) U.S. Cl. 428/613; 419/2; 419/62

(57) ABSTRACT

Porous metal foam structures and methods of making the same are described. Preferred methods include the steps of combining a liquid-extractable, pore-forming agent with a metal powder in the presence of a liquid in which the pore-forming agent is soluble, thereby forming a mixture, compacting the mixture to form a green body, and dissolving the pore-forming agent from the green body to produce a metal skeleton.

### FIELD

The present invention relates to porous metal foam structures and methods of making the same.

### BACKGROUND

Porous metal foam structures have a number of uses, including as medical implants. Porosity in such structures can be achieved by mixing the metal as a powder with a pore-forming agent (PFA) and then pressing the mixture into the desired shape to form a green body. After the PFA is removed, the metal skeleton can be sintered to achieve the desired properties for the porous metal foam structure.

One way of removing the PFA from the green body is to “burn out” the PFA. This can lead to a variety of potential problems, such as contamination of the furnace, formation of undesirable metal compounds in the porous structure induced by the reaction between the metal and PFA, and usage of relatively large amounts of energy. There are also certain storage problems associated with green bodies produced in this manner, including noxious odor formation.

Thus, what is needed is alternative ways of creating porous metal foam structures.

### SUMMARY

One aspect of the present invention provides processes that comprise combining a liquid-extractable, pore-forming agent with a metal powder in the presence of a liquid in which the pore-forming agent is soluble, thereby forming a mixture that is compacted to form a green body. The pore-forming agent is then dissolved from the green body to produce a metal skeleton that can be sintered to form a sintered metal foam structure such as a porous metal implant. The present invention also provides porous metal implants and other sintered foam structured produced by such methods.

### BRIEF DESCRIPTION OF THE DRAWINGS

The numerous objects and advantages of the present invention may be better understood by those skilled in the art by reference to the accompanying non-scale figures, which are provided by way of example and are not intended to limit the invention.

FIG. 1 is a schematic of a process of making a porous metal implant according to one embodiment of the present invention.

FIG. 2 is an image of a sintered metal foam structure.

FIG. 3 is an image of the sintered metal foam structure of FIG. 2 in a side view.

FIG. 4 is an image of the sintered metal foam structure of FIG. 2 in a detail view.

FIG. 5 is an optical microscope image of the sintered metal foam structure of FIG. 2.

FIG. 6 is a scanning electron microscope (SEM) image of a sintered metal foam structure at 200× magnification.

FIG. 7 is a SEM image of the sintered metal foam structure at 700× magnification.

### DETAILED DESCRIPTION

The present invention provides processes that involve combining a liquid-extractable pore-forming agent (PFA) with a metal powder in the presence of a liquid in which the PFA is soluble. It is understood that possible PFA/liquids combinations include PFAs that are soluble in organic liquids paired with an organic liquid, or PFAs that are soluble in non-organic liquids paired with a non-organic liquid.

In certain embodiments, the liquid is aqueous. Preferably, the liquid includes at least about 75 weight percent water, more preferably at least about 90 weight percent water, even more preferably at least about 95 weight percent water. Representative liquids include water (such as reverse osmosis water, deionized water, distilled water, and/or deoxygenated water) or an aqueous carbohydrate solution.

Although the amount of liquid used will depend upon the nature of the metal powder and PFA and the processing conditions employed, it has been found that the use of about 450 μL to about 1050 μL per 100 cm³ of the pre-compaction mixture should be used, more preferably about 600 μL to about 750 μL per 100 cm³ of pre-compaction mixture.

PFAs according to the present invention are particulate materials that are soluble in a fluid of interest. Representative PFAs include sodium chloride, ammonium chloride, calcium chloride, magnesium chloride, aluminum chloride, potassium chloride, nickel chloride, zinc chloride, ammonium bicarbonate, sodium hydrogen phosphate, sodium dihydrogen phosphate, potassium dihydrogen phosphate, potassium hydrogen phosphate, potassium hydrogen phosphite, potassium phosphate, magnesium sulfate, potassium sulfate, alkaline earth metal halides, crystalline carbohydrates (including sucrose and lactose classified as monosaccharides, disaccharides, and trisaccharides), polyvinyl alcohol (PVA), polyethylene oxide, a polypropylene wax (such those available from Micro Powders, Inc., Tarrytown, N.Y., under the PROPYLTEX™), sodium carboxymethyl cellulose (SCMC), polyethyleglycol-polypropylene-polyethyleneglycol copolymers (PEG-PPG-PEG, such as those available from BASF, Ludwigshafen, Germany under the PLURONIC™), and combinations thereof.

The PFA can be present in a wide variety of particle sizes and particle size distributions suitable to produce a pore size and pore size distribution. Certain preferred particle size ranges are from about 200 μm to about 600 μm, from about 200 μm to about 350 μm, and from about 350 μm to about 550 μm.

Virtually any type of metal powder known in the field of powder metallurgy can be used in the methods of the present invention. Preferred metal powders are those that are formed from titanium, cobalt, chromium, nickel, magnesium, tantalum, niobium, zirconium, aluminum, copper, molybdenum, tungsten, stainless steel, or alloys thereof (e.g., Co—Cr alloy). In one embodiment, the metal powder is titanium or a titanium alloy such as Ti-6Al-4V.

The metal powder also can be present in a wide variety of particle sizes and particle size distributions. Certain preferred particle size ranges are from about 20 μm to about 100 μm, from about 25 μm to about 50 μm, and from about 50 μm to about 80 μm.

Those skilled in the art will recognize that the proportions of metal powder and PFA will vary depending upon the type of structure sought to be produced. In certain embodiments of the present invention, the ratio of metal powder to PFA is about 40:60 to about 10:90, preferably about 25:75 with the PFA.

After the metal powder, PFA, and liquid are mixed, the resulting mixture is compacted to form a green body. The compacting step can be carried out via any of the many techniques known in the art, including uniaxial die and punch, biaxial die and punch, or cold or rubber isostatic press. In certain embodiments of the invention, the compacting pressure is from about 20 ksi to about 60 ksi, preferably from about 30 ksi to about 45 ksi. Once formed, the green body may be machined by any of the techniques known in the art, such as cutting, milling, turning, drilling, and/or facing.

The PFA can be removed from the green body using any liquid capable of dissolving the PFA, thus revealing the metal skeleton. As with the liquid that is mixed with the metal powder and PFA prior to compaction, the dissolving liquid is preferably aqueous, and more preferably water (such as reverse osmosis water, deionized water, distilled water, and/or deoxygenated water) or an aqueous carbohydrate solution. The liquid that is used to dissolve the PFA can be the same as or different than the liquid that is mixed with the metal powder and PFA prior to compaction, e.g., the chemical identity of the components in the respective liquids and/or their relative proportions can be the same or different.

The dissolution step can be effected by, for example, immersing the green body in a bath containing a liquid in which it is soluble or contacting the green body with a stream of that liquid. The temperature range for the liquid used in the dissolution step is above its freezing point but below its boiling point, and preferably about 50° F. to about 176° F. (about 10° C. to about 80° C.). Certain steps known to affect dissolution may be implemented, for example, the bath solution can be circulated or portions of the bath solution periodically replaced with fresh solution.

The metal skeleton obtained upon removal of the PFA may also be machined, such as by cutting, milling, turning, drilling, and/or facing the skeleton.

The metal skeleton typically will be sintered to impart the desired properties. While all suitable sintering conditions are contemplated, sintering for titanium or Ti-6Al-4V alloy typically will be performed at temperatures of from about 2100° F. to about 2700° F. (preferably about 2500° F.) and/or for about 2 hr to about 10 hr (preferably about 3 hr to about 6 hr).

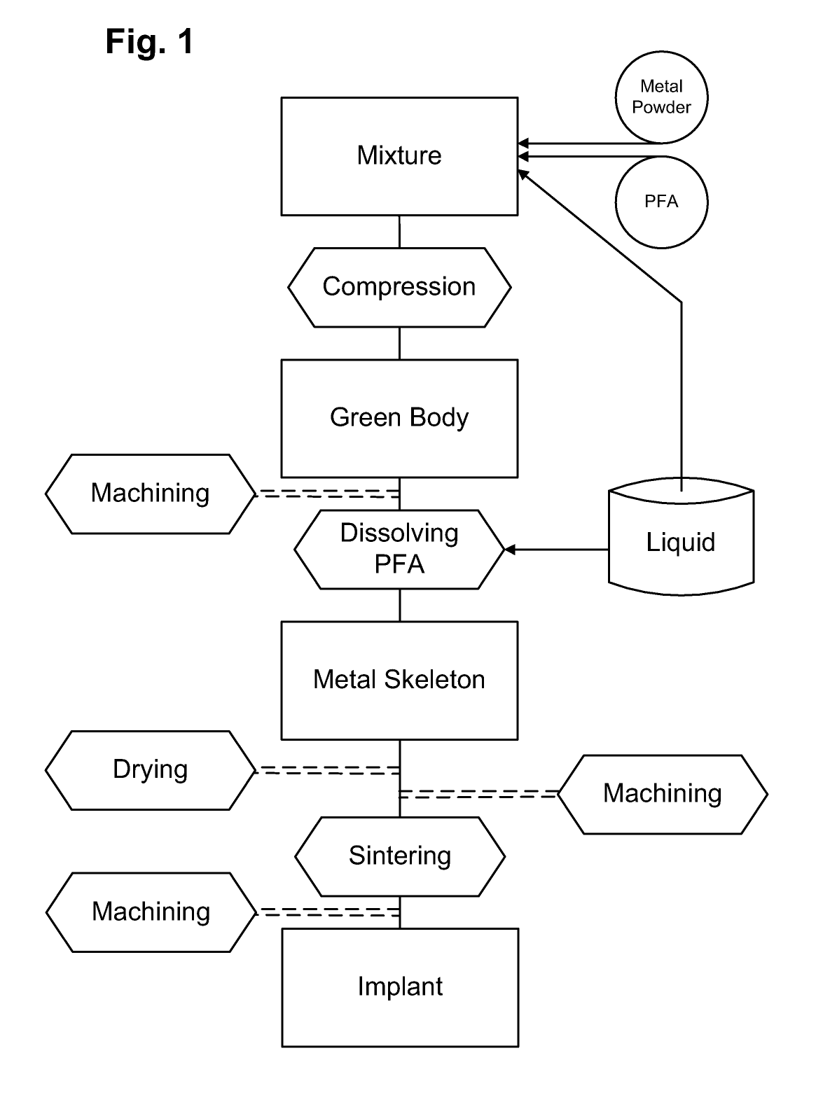

The methods of the invention can be used, for example, to produce metal implants that include a porous surface. Referring now to FIG. 1, certain processes for making such implants are depicted. Metal powder, PFA, and a liquid in which the PFA is soluble are combined to form a mixture. The mixture is compressed (for example via uniaxial, multi-axial, or isostatic compaction) in a shaped mold to form a green body. The mold determines the shape of the implant, and thus should generally be of a desired shape to avoid or at least minimize the need for substantial machining. The PFA is dissolved from the green body through contact with a liquid in which the PFA is soluble to form a metal skeleton. Optionally, the metal skeleton may be machined and/or dried to remove residual liquid. The metal skeleton is sintered, and afterwards optionally machined to form a porous metal implant. Those skilled in the art are aware of suitable shapes for such implants and the properties that they should possess, for example suitable compressive yield strength. Although the first liquid and second liquid are depicted as coming from the same source in FIG. 1, it is understood that the liquids need not be identical, only that they each be a liquid in which the pore-forming agent is soluble.

The surface of the porous metal implant may be roughened. Methods of roughening include at least one of grit blasting, etching, or plasma sputtering and are known in the art. A preferred method of etching is the etching method of United States Patent Application 2004/0167633, the entire disclosure which is herein incorporated by reference. A preferred method of grit blasting uses a water soluble grit, such as NaCl, to blast against the implant, thus allowing for removal of impacted grit from the pores by dissolution in an aqueous liquid.

In certain embodiments, the present invention provides metal implants or other types of metal skeletons having a porosity of from about 60% to about 85% (preferably about 65% to about 75%) as measured by volume, the forced intrusion of liquid mercury, and cross-section image analysis. It is understood that the porosity can be a product of metal to PFA ratio, PFA size, or a combination thereof.

In one embodiment, preferred pure titanium skeletons are those that have a tensile strength of at least about 35 MPa (as measured by the standard tension testing—ASTM E8-99), or a flexural yield strength of at least about 90 MPa (as measured by three-point bend testing—ASTM E290-97a), and/or a compressive yield strength of at least about 65 MPa (as measured by monotonic compression testing—ASTM E9-89a) at a porosity of about 65%. Particularly preferred pure titanium skeletons are those that have a tensile strength of at least about 40 MPa (measured via ASTM E8-99), or with a flexural yield strength of at least about 110 MPa (measured via ASTM E290-97a), and/or with a compressive yield strength of at least about 75 MPa (measured via ASTM E9-89a) at a porosity of about 65%.

It is understood that titanium alloys can be used to obtain greater strengths. Preferred titanium alloy skeletons are those that have a tensile strength of at least about 60 MPa (measured via ASTM E8-99), or with a flexural yield strength of at least about 120 MPa (measured via ASTM E290-97a), and/or with a compressive yield strength of at least about 90 MPa (measured via ASTM E9-89a) at a porosity of about 65%. Particularly preferred titanium alloy skeletons are those that have a tensile strength of at least about 90 MPa (measured via ASTM E8-99), or with a flexural yield strength of at least about 180 MPa (measured via ASTM E290-97a), and/or with a compressive yield strength of at least about 110 MPa (measured via ASTM E9-89a) at a porosity of about 65%.

While not intending to be bound by theory, it is believed that porosity, metal powder particle size, and sintering temperature are important factors contributing to the strength of the resulting structure.

### EXAMPLES

The present invention will be further described in the following examples, which are not intended to be limiting.

### Example 1

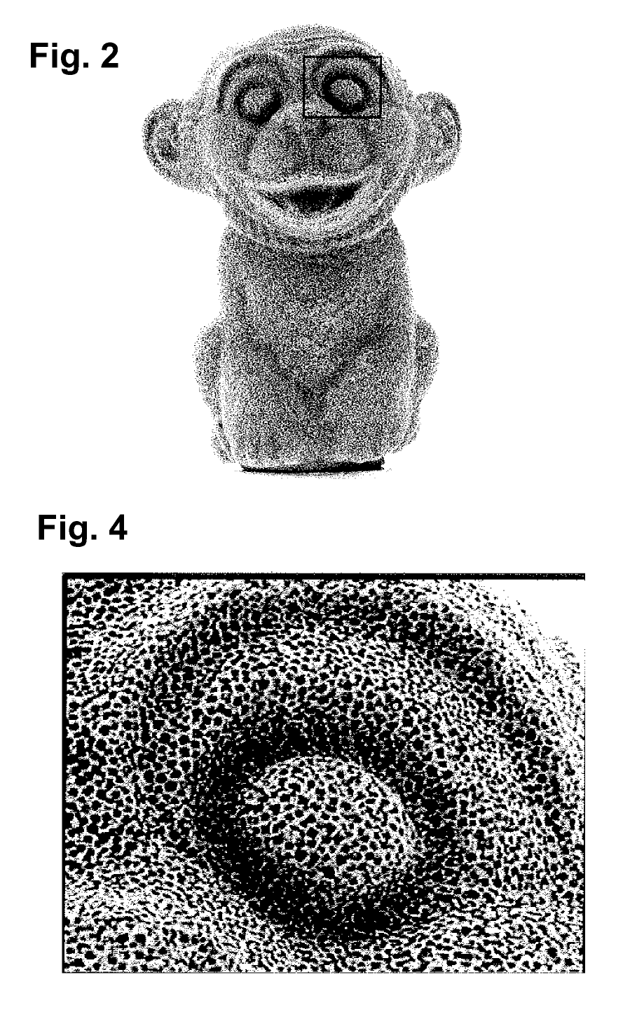

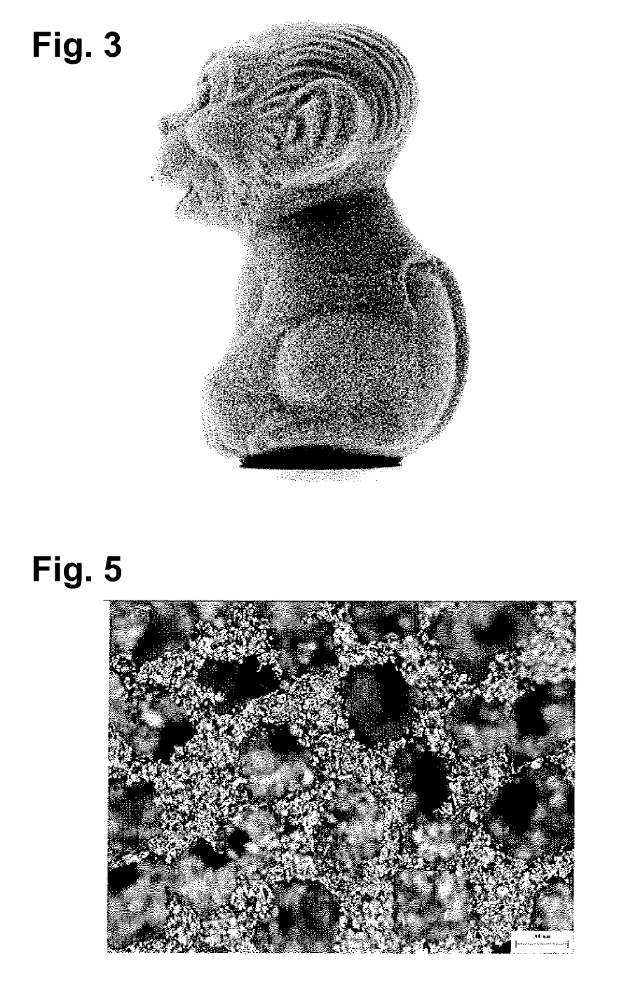

Commercial pure titanium powder (Phelly Materials, Inc. Bergenfield, N.J., USA) particle size: 45-75 μm and NaCl (Fisher Scientific International Inc. Hampton, N.H., USA) particle size: 250-425 μm, as a PFA, were mixed in a ratio of approximately 25:75 Ti:PFA by volume. Reverse osmosis water was added in an amount corresponding to about 700 μL per 100 cm³ of Ti:PFA mixture. The mixture was added to a mold and compressed into a green body at a compaction pressure of 22 ksi. The green body was placed in a water bath until the NaCl dissolved. The resulting metal skeleton was dried at 65° C. for 4 hours, and then sintered at 1204° C. for 2 hrs. The sintered metal foam structure is depicted in FIGS. 2-5, which show a highly porous metal foam structure in a complex shape.

### Example 2

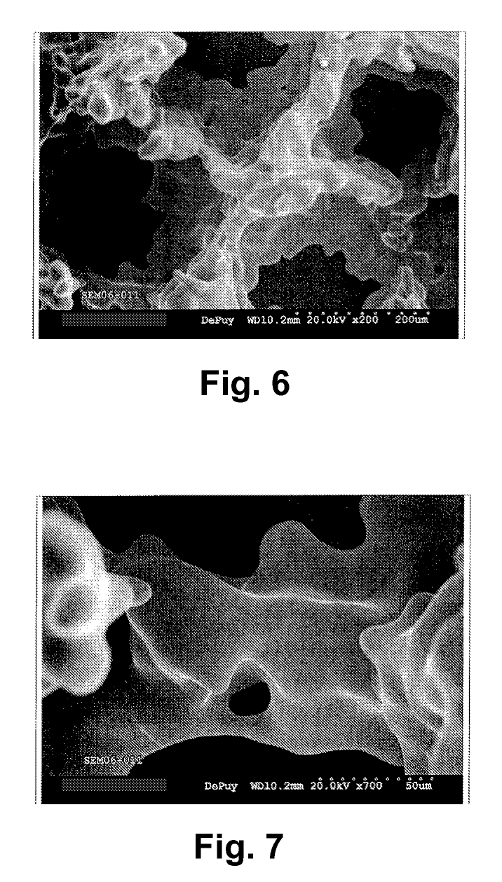

Commercial pure titanium powder particle size: 45-75 μm and NaCl particle size: 250-425 μm, as a PFA, were mixed in a ratio of approximately 20:80 Ti:PFA by volume. Reverse osmosis water was added in an amount corresponding to about 700 μL per 100 cm³ of Ti:PFA mixture. The mixture was added to a mold and compressed into a green body at a compaction pressure of 23.6 ksi. The green body was placed in a water bath until the NaCl dissolved. The resulting metal skeleton was first dried in the oven as in Example 1 and then sintered at 1371° C. for 3 hrs. The sintered metal foam structure is depicted in FIGS. 6-7.

### Example 3

Titanium powder (32-45 μm (500-350 mesh)) and NaCl (425-500 μm) were mixed in a ratio of approximately 25:75 Ti:PFA by volume. Reverse osmosis water was added in an amount corresponding to about 700 μL per 100 cm³ of Ti:PFA mixture. The mixture was added to a mold and compressed into a green body at a compaction pressure of 30 ksi. The green body was placed in a water bath for about 12 hours to allow the PFA to dissolve. The resulting metal skeleton was sintered at 1731° C. for 6 hrs. The sintered metal foam structures had about 65% porosity. The compressive yield strength and flexural yield strength were 82 MPa and 180 MPa, respectively, determined by performing the standard compression test and three-point bend test following ASTM E9-89a and ASTM E290-97a.

### Example 4

Titanium powder (32-45 μm (500-350 mesh)) and NaCl (250-300 μm) were mixed in a ratio of approximately 25:75 Ti:PFA by volume. Reverse osmosis water was added in an amount corresponding to about 700 μL per 100 cm³ of Ti:PFA mixture. The mixture was added to a mold and compressed into a green body at a compaction pressure of 45 ksi. The green body was placed in a water bath for about 12 hours to allow the PFA to dissolve. The resulting metal skeleton was sintered at 1371° C. for 6 hrs. The sintered metal foam structures had about 65% porosity. The compressive yield strength and flexural yield strength were 77 MPa and 196 MPa, respectively, determined as described above with reference to Example 3.

In the foregoing specification, the concepts have been described with reference to specific embodiments. Many aspects and embodiments have been described above and are merely exemplary and not limiting. After reading this specification, skilled artisans appreciate that other aspects and embodiments are possible without departing from the scope of the invention. Moreover, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause the same to occur or become more pronounced are not to be construed as a critical, required, or essential feature of any or all the claims.

It is to be appreciated that certain features are, for clarity, described herein in the context of separate embodiments, but may also be provided in combination in a single embodiment. Conversely, various features that are, for brevity, described in the context of a single embodiment, may also be provided separately or in any subcombination. Further, reference to values stated in ranges includes each and every value within that range.

1. A process comprising the steps of:
combining a liquid-extractable, pore-forming agent with a metal powder, and a first liquid in which the pore-forming agent is soluble, thereby forming a mixture;
compacting the mixture to form a green body; and
dissolving the pore-forming agent in a second liquid in which the pore-forming agent is soluble, thereby producing a metal skeleton.

2. The process of claim 1, wherein the first liquid is aqueous.

3. The process of claim 1, wherein about 450 μL to about 1050 μL of said first liquid is mixed with said pore-forming agent and said metal powder per each 100 cm³ of said mixture.

4. The process of claim 1, wherein about 600 μL to about 750 μL of said first liquid is mixed with said pore-forming agent and said metal powder per each 100 cm³ of said mixture.

5. The process of claim 1, wherein the first liquid is reverse osmosis water, deionized water, distilled water, deoxygenated water, demineralized water, or an aqueous carbohydrate solution.

6. The process of claim 1, wherein the first liquid is at least about 75 weight percent water.

7. The process of claim 1, wherein the pore-forming agent is sodium chloride, ammonium chloride, calcium chloride, magnesium chloride, aluminum chloride, potassium chloride, nickel chloride, zinc chloride, ammonium bicarbonate, sodium hydrogen phosphate, sodium dihydrogen phosphate, potassium dihydrogen phosphate, potassium hydrogen phosphate, potassium hydrogen phosphite, potassium phosphate, magnesium sulfate, potassium sulfate, an alkaline earth metal halide, a crystalline carbohydrate, polyvinyl alcohol (PVA), polyethylene oxide, polypropylene wax, sodium carboxymethyl cellulose (SCMC), polyethyleglycol-polypropylene-polyethyleneglycol copolymer (PEG-PPG-PEG), or a combination thereof.

8. The process of claim 1, wherein the pore-forming agent has a particle size of about 200 μm to about 600 μm.

9. The process of claim 1, wherein the pore-forming agent has a particle size of about 200 μm to about 350 μm.

10. The process of claim 1, wherein the pore-forming agent has a particle size of about 350 μm to about 550 μm.

11. The process of claim 1, wherein the metal powder is formed from titanium, cobalt, chromium, nickel, magnesium, tantalum, niobium, zirconium, aluminum, copper, molybdenum, tungsten, stainless steel, or an alloy thereof.

12. The process of claim 1, wherein the metal powder is titanium or an alloy of titanium.

13. The process of claim 1, wherein the metal powder has a particle size of about 20 μm to about 100 μm.

14. The process of claim 1, wherein the metal powder has a particle size of about 25 μm to about 50 μm.

15. The process of claim 1, wherein the metal powder has a particle size of about 50 μm to about 80 μm.

16. The process of claim 1, wherein the first liquid and the second liquid are the same.

17. The process of claim 1, wherein the first liquid and the second liquid are different.

18. The process of claim 1, wherein the second liquid is aqueous.

19. The process of claim 1, wherein the metal powder is in a ratio of volume about 40:60 to about 10:90 with the pore forming agent.

20. The process of claim 1, wherein the metal powder is in a ratio of volume about 25:75 with the pore forming agent.

21. The process of claim 1, further comprising sintering the metal skeleton to form a porous metal implant, wherein the sintering temperature is in a range from about 2100° F. to about 2700° F.

22. A metal implant having:
at least one of:
a flexural yield strength of at least 90 MPa, and
a compressive yield strength of at least 65 MPa,
said implant having been formed from a mixture of a liquid extractable pore forming agent and a metal powder, and having at least 65% porosity.
